(19) United States
(12) Patent Application Publication
(10) Pub. No.: US 2009/0104329 A1
(43) Pub. Date: Apr. 23, 2009

(54) Method for heating a meal and cooking appliance which is mounted in an elevated manner

(75) Inventors: Ingo Bally, Traunstein (DE); Kerstin Feldmann, Bretten (DE); Wolfgang Fuchs, Altenmarkt a.d. Alz (DE); Martin Keller, Traunreut (DE); Edmund Kuttalek, Grassau (DE); Maximilian Neuhauser, Chieming/Egerer (DE); Klemens Roch, Troslberg (DE); Wolfgang Schnell, Trostberg (DE); Guenter Zschau, Traunwalchen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgeraete GmbH, Muenchen (DE)

(21) Appl. No.: 11/990,541

(22) PCT Filed: Jul. 26, 2006
(86) PCT No.: PCT/EP2006/064697

§ 371 Date: Feb. 14, 2008

(30) Foreign Application Priority Data
Aug. 17, 2005 (DE) 102005038880.9

(51) Int. Cl. A21B 1/22; A23L 1/01; H05B 6/80

(52) U.S. Cl. 426/523; 219/391; 219/725

(57) ABSTRACT

A method for heating a meal in a closed cooking appliance which is mounted in an elevated manner. Said elevated cooking appliance comprises at least one muffle which comprises a muffle opening and which defines a cooking area, a base door which closes the muffle opening and a ceramic hob which is arranged in the base door. Said method comprises the following steps: (a) at least one meal is placed on the ceramic hob, without cooking utensils, when the cooking appliance, which is mounted in an elevated manner, is in the open state, (b) the elevated cooking appliance is closed and (c) the at least one meal is heated at least by contact heat from the heated ceramic hob when the elevated cooking appliance is in the closed state.

The present invention relates to a method for heating a meal or food to be cooked in a closed high-level cooking appliance with at least one muffle defining a cooking area with a muffle opening, a—motorized or manually operated base door for closing the muffle opening and a ceramic cooking zone which is arranged in the base door, as well as a high-level cooking appliance.

The process of placing food to be cooked on a support and then pushing the support into the oven along a guide for heating the food is known from ovens. In such cases the meal can be heated up rapidly by pre-heating or by a high temperature in the oven. This disadvantage is that this heating-up process takes a comparatively long time.

Also known is the process of rapidly heating up a meal by radiated heat from heating elements and heating lamps typically mounted in the roof of the oven, e.g. halogen lamps. The disadvantage here is the additional equipment outlay and a possible soiling and burning out of the lamps. Here too there is the danger of burning the meal on its—generally exposed surface.

DE 100 59 652 A1 for example discloses a generic high-level cooking appliance in which a cooking zone can be used in the open state in a hotplate operating mode and in a closed state in a bottom heat operating mode. With this appliance the meals are laid on supports for the items to be cooked which are pushed into holder parts so that in the closed state the food is arranged as it would be in an oven with baking trays.

The object of the present invention is thus to create an opportunity for faster but still even heating of meals, especially for cooking frozen meals.

The present object is achieved by the method with the features of claim 1 and by the appliance as claimed in claim 15.

To this end the method features the following steps:

(a) Laying at least one meal on the cooking zone in a open state of the high-level cooking appliance and doing this without cooking utensils or accessories such as pots, pans or such like,
(b) Closing the high-level cooking appliance and
(c) Heating at least one meal in the closed state of the high-level cooking appliance at least through the contact heat from the heated cooking zone. The contact heat provides a rapid response compared to hot air and heats correspondingly rapidly.

So that the meal is heated up evenly, it is additionally heated in step (c) by hot air and/or radiated heat which originates from other heating elements, such as a ring element and/or an overhead heating element for example. Especially when hot air is used, it is advantageous for the cooking zone to heat up relatively quickly, whereas the hot air typically takes some time to increase the temperature in the cooking space significantly. Through this difference in the heating-up time the meal on the cooking zone is heated up rapidly e.g. defrosted, and then—with now sufficiently hot heating air—completely cooked or heated through. This process avoids an uneven cooking of meals, and time savings are produced since, inter alia, preheating or separate defrosting are no longer necessary. A typical application environment is the preparation of frozen pizza, which can be fully prepared with this method without preheating in 10 minutes.

Preferably the cooking space is heated by the cooking zone and a hot air function, but additionally or alternatively to hot air in step (c) the meal can also be heated by radiation heat.

The meal can, depending on consistency for example, be laid directly on the cooking zone, e.g. frozen pizza. The meal can however also be laid in a mold, a roasting dish, a foil tray or on a metal sheet on the cooking zone, e.g. cakes. In this case the intermediate layers do not significantly prevent the heat being conducted.

So that the cooking zone warms up quickly, it advantageously features at least one heating element and a cover made of ceramic glass or of a thin metal sheet. The ceramic glass preferably features a printed area, within which the items for cooking or the meal can be laid.

Especially with frozen meals, such as pre-cooked frozen meals, it is advantageous for fast preparation or cooking for the cooking appliance to be operated at high, especially maximum, heat power, especially at 3.6 KW. In this fast cooking process the high, especially maximum, power is maintained all the time, by contrast with the known cooking processes. Thus no rapid heating-up is employed here, in which there is only strong heating to start with so that the heat can then be reduced again once a preset temperature has been reached. This produces savings in time of up to 30%.

It is advantageous for even cooking of the (frozen) meals for the cooking zone (15) to be operated with a heat power which on average amounts to 40% of the entire heat power, especially up to 30%, specifically between 15% and 20% of the total heat power. The heat power is timed within a heat cycle; the heating elements can be operated in different ways in such cases. If the cooking zone is operated with a heat power of 15-20% of the total heat power, it is useful for the remaining heat power to be distributed to a ring heating element and/or an overhead heating element and/or a radiant heating element, e.g. a halogen lamp. In this case it is especially useful for the heat power of the ring heating element to amount to around 25% of the total heat power and the heat power of the overhead heating element to amount to around 55-60%.

Usefully the fan is operated for generating the hot air, especially at maximum fan power.

It is especially advantageous for a memory unit for storing fast-cook programs to be present, in which for example fast-cook programs for various frequently-cooked meals or meal types are stored, and thereby are also able to be retrieved by the user. The fast-cook programs can for example differ in the operation of the hotplate in hotplate or bottom heating mode and/or in the relative heat power of the different heating elements to each other and/or the duration. For especially convenient operation, for a fast-cook mode of operation only the meal type or—class and possibly a weight of the meal need be set. It is especially useful for the fast-cook programs to be able to be set by the user, e.g. the temperature or heating duration is able to be set to adapt the heating operation to the individual taste of the user. It is useful for the settings to be able to be reset to ex-works settings which can then be stored for example in a non-volatile memory, e.g. an (EE)PROM, or even a read-only memory, e.g. a ROM.

An exemplary embodiment of the invention is described schematically in detail below with reference to the enclosed figures. The figures show:

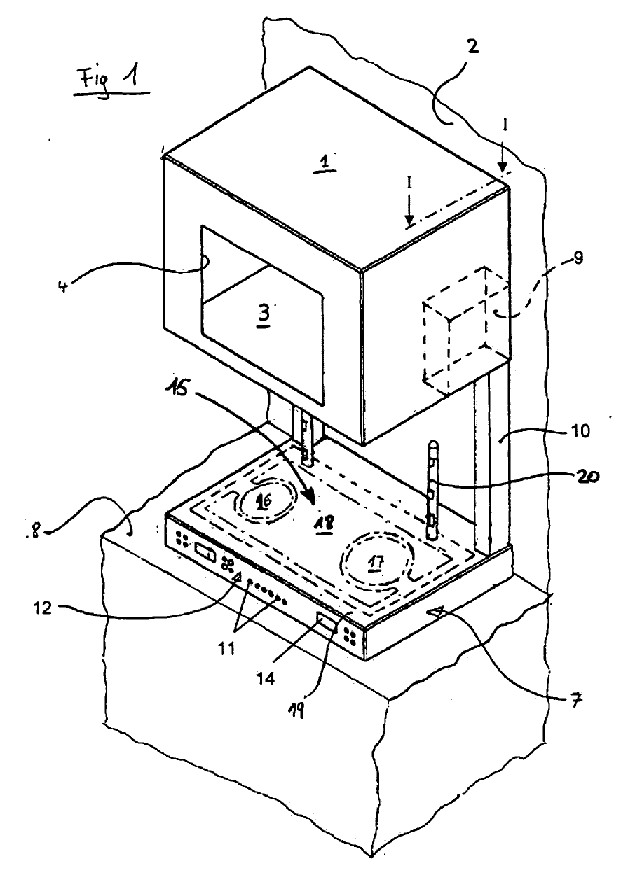

FIG. 1 a perspective view of a cooking appliance mounted in a high-level position on a wall with lowered base door;

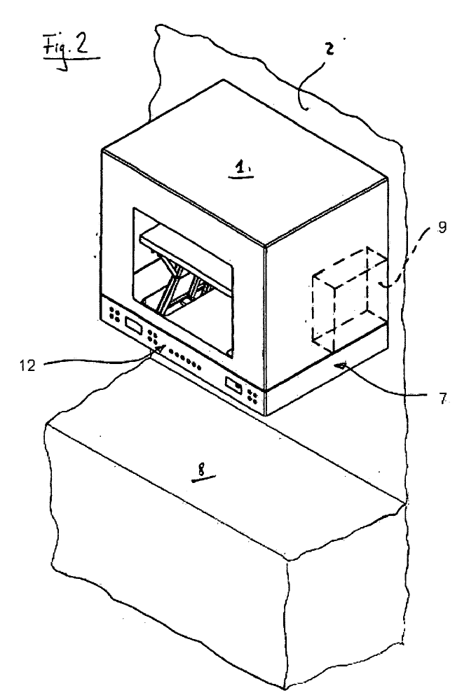

FIG. 2 a perspective view of the high-level cooking appliance with closed base door;

FIG. 3 a perspective view of a housing of the high-level cooking appliance from below without the base door;

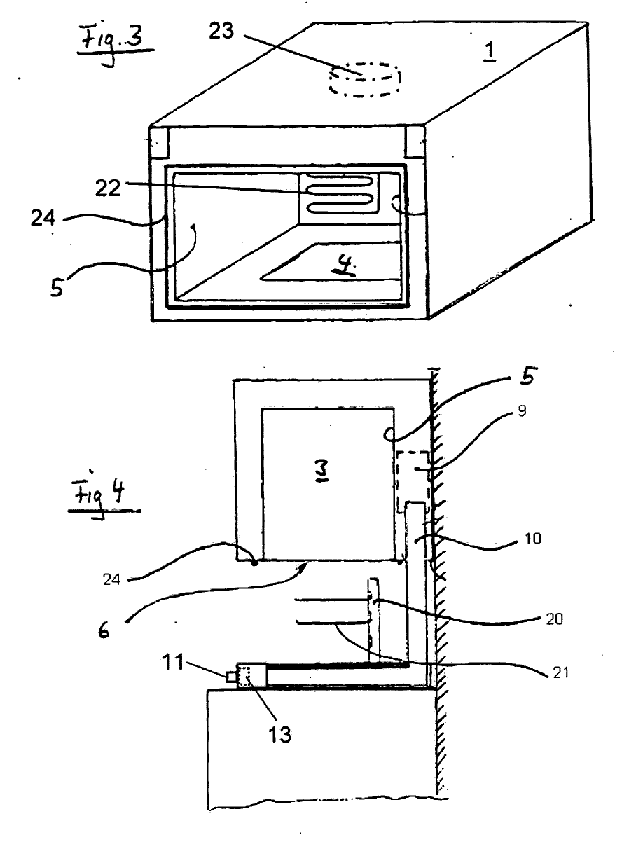

FIG. 4 a schematic side view of the high-level cooking appliance mounted on the wall with lowered base door along intersection line I-I from FIG. 1;

FIG. 5 shows a sketch of a control circuit;

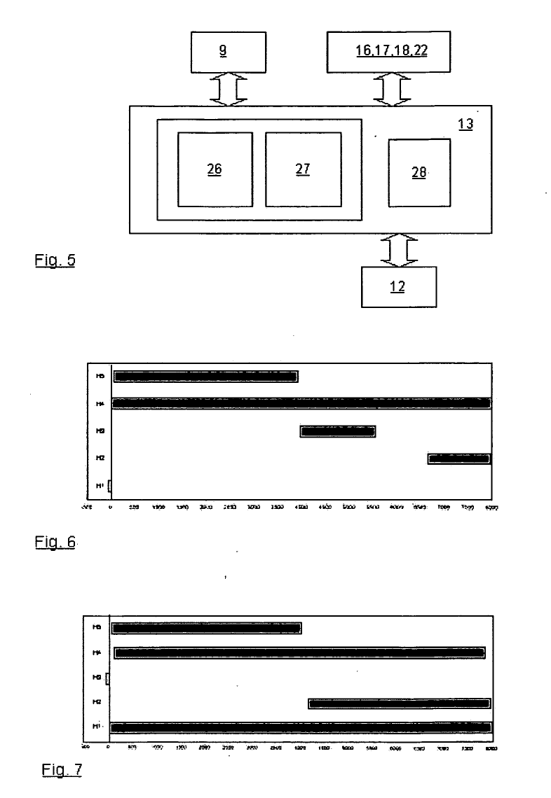

FIG. 6 shows a distribution of the heat power with hot air operation;

FIG. 7 shows a distribution of the heat power with fast-cook operation.

FIG. 1 shows a high-level cooking appliance with a housing 1. The rear of the housing 1 is mounted on a wall 2 in the manner of a wall-mounted cupboard. A cooking space 3 is defined in the housing 1, which can be checked via a viewing window 4 set into the front of the housing 1. It can be seen from FIG. 4 that the cooking space 3 is delimited by a muffle 5, which is provided by a heat-insulating jacket not shown in the figure and that the muffle 5 features a muffle opening 6 on the base side. The muffle opening 6 can be closed by a base door 7. FIG. 1 shows the base door 7 in a lowered position, in which its lower side is in contact with a work surface 8 of a kitchen unit. To close off the cooking space 3, the base door 7 should be moved into the position shown in FIG. 2 known as the “zero position”. To adjust the position of the base door 7 the high-level cooking appliance has a drive apparatus 9, 10. The drive apparatus 9, 10 has a drive motor 9, shown in FIGS. 1, 2 and 4 by the dashed outline, which is arranged between the muffle 5 and an outer wall of the housing 1. The drive motor 9 is arranged in the area of the rear of the housing 1 and, as shown in FIG. 1 or 4, is actively connected to a pair of lifting elements 10, which are connected to the base door 7. In this case, as depicted in the schematic side view shown in FIG. 4, each lifting element 10 is designed as an L-shaped support, of which the vertical arm extends downwards from the housing-side drive motor 9. To position the base door 7 the drive motor 9 can be actuated with the aid of a control panel 12 and a control switch 13 which is arranged as shown in FIGS. 1 and 2 on the front of the base door 7. As shown in FIG. 4, the control circuit 13 is located behind the control panel 12 within the base door 7. The control circuit 13, which consists here of a number of circuit boards in different locations and performing different functions, and communicating via a central communication bus, represents a central control unit for appliance operation and controls and/or regulates for example heating up, movement of the base door 3, implementation of user entries, an illumination, anti-trapping measures, timing of the heating elements 16, 17, 18, 22 and much more besides.

It can be seen from FIG. 1 that an upper side of the base door 7 features a cooking zone 15. Almost the entire surface of the cooking zone 15 is taken up by heating elements 16, 17, 18 which are shown as dashed outlines in FIG. 1. In FIG. 1 the heating elements 16, 17 are two separate different-sized hotplate elements, whereas heating element 18 is a radiant heating element provided between the two hotplate heating elements 16,17 which practically surrounds the hotplate heating elements 16, 17. Hotplate heating elements 16, 17 define associated cooking zones or cooking areas for the user; hotplate heating elements 16, 17 together with radiant heating element 18 define a bottom heat zone. The zones can be indicated by a suitable decor on the surface. Heating elements 16, 17, 18 can each be activated via the control circuit 13.

In the exemplary embodiment shown the heating elements 16, 17, 18 are embodied as radiant heating elements which are covered by a glass ceramic plate 19. The glass ceramic plate 19 has approximately the same dimensions as the upper side of the base door 7. The glass ceramic plate 19 is also equipped with installation openings (not shown), through which sockets for holding holder elements 20 for pot supports 21 extend, as shown in FIG. 4. Instead of a glass ceramic plate 19 other—preferably fast-response—covers can also be used, e.g. a thin metal sheet.

With the aid of a control knob provided in the control panel 12 the high-level cooking appliance can be switched to a hotplate or a bottom heat operating mode, which will be explained below.

In the hotplate operating mode the hotplate heating elements 16, 17 can be activated individually by means of control elements 11, which are provided in the control panel 12, via the control circuit 13, whereas the radiant heating element 18 remains inoperative. The hotplate operating mode can be executed with the base door 7 lowered as shown in FIG. 1. It can however also be operated in a closed cooking space 3 with a raised base door 7 in an energy saving function.

In the bottom heat operating mode, not only the hotplate heating elements 16, 17 but also the radiant heating element 18 are activated by the control circuit 13.

In order to achieve the most even possible browning profile of the food being cooked during bottom heat operation, it is of decisive importance for the cooking zone 15 providing the bottom heat to have an even distribution of the heat power output over the surface of the cooking zone 15, although the heating elements 16, 17, 18 have different rated outputs. Preferably the heating elements 16, 17, 18 are thus not switched on permanently by the control circuit 13 but the power supply to the heating elements 16, 17, 18 is timed. In this case the different levels of rated heating power of the heating elements 16, 17, 18 are reduced so that the heating elements 16, 17, 18 create an even distribution of the heating power output over the surface of the cooking zone 15.

FIG. 4 is a schematic diagram of the position of a fan 23, for creating air circulation for example in a hot air mode or for supplying fresh air. In addition an overhead heating element 22 accommodated on an upper side of the muffle 5 is provided, which can be designed with one circuit or two circuits, e.g. with an inner and an outer circuit. Further heating elements—not shown here for reasons of clarity—such as a ring heating element between the rear wall of the housing 1 and the muffle can also be present here. The different operating modes, such as top heat, hot air or fast-cook mode as well, can also be set by the control circuit 13 by appropriate switching-on and setting of the heat power of the heating elements 16, 17, 18, 22, if necessary with activation of the fan 23 as well. The heat power can be set by suitable timing. In addition the cooking zone 15 can also be of a different design, e.g. with or without an extended cooking zone, as a pure—single or multi-circuit heat retention zone without cooking areas and so forth. The housing 1 has a seal 24 against the base door 7.

The control panel 12 is primarily arranged on the front of the base door 7. Other alternative arrangements are also conceivable, e.g. on the front of the housing 1, divided up into different subpanels and/or partly on side surfaces of the cooking appliance. Further embodiments are possible. The design of the control elements 11 is not restricted and can for example include control knobs, rocker switches, pushbuttons and foil switches which include display elements 14, e.g. LED, LCD and/or touchscreen displays.

The control device 13 from FIG. 4 comprises at least one memory unit (not shown) for storing heating programs with a non user-settable memory area, in the form of a ROM and with user-settable memory area in the form of an EEPROM. The EEPROM ensures that self-configured or self-created heating programs are not deleted if there is a power outage. Alternatively RAMs can be used together with a power failure bridging device.

Heating programs can be selected and activated via the control panel 12. To this end one of the control elements 11 is configured as a heating program selection switch, for example as a rotary switch without a stop position, with the heating programs being cycled through by turning the switch. On activation of the heating program selection switch, which can also be a multi-function switch able to be set by further control elements 11, a numeric or alphanumeric display 14 displays the corresponding heating program. Using a control element 11 as a reset switch a specific heating program or all heating programs can be reset to the ex-works setting. Another of the control elements 11 can be embodied as a confirmation key for activating the respective function.

In fast-cook mode the cooking zone 15—for example in its bottom heat mode—and at least one further heating element are operated simultaneously, e.g. a ring heating element and/or an overhead heating element, which can be embodied and activated as a single circuit or as a number of circuits. In this case the cooking appliance is operated continuously at maximum power. Simultaneously the fan 23 circulates the heated air around in the cooking space 3. The maximum rated heat power amounts in this embodiment to 3.6 KW.

The activation of the fast cooking mode by pressing a corresponding key (digit combination) on the control panel 12 includes an automatic movement of the base door 7 from an open into a closed state, preferably with activated anti-jamming protection.

In FIG. 5 the control circuit 13 is described in greater detail in a schematic diagram. It has a memory area for storage of heating programs with a user-settable memory area 26 in the form of an EEPROM and a non user-settable memory area 27 in the form of a ROM or likewise of an EEPROM. The memory 26, 27 is read out by a microcontroller 28 which, after setting and activation of a heating program by the control unit 12, activates the heating elements 16-18, 22 on the basis of selected heating parameters and if necessary the drive motor 9 as well, for example when switching over from the open to the closed state of the base door 7 or the heating space 3, or vice versa. The reading out of the memory 26, 27 by the microcontroller is not restricted to a specific manner: Thus for example the non-user-settable memory area 26 can be read out first and then overwritten with the data present in the user-settable memory area 27, where this has been changed by a user. As an alternative, only the user-settable memory area 27 is read out, which is overwritten after a reset by the non-user settable memory area 27. The microcontroller 28 can also trigger a ‘reset’ function, which either deletes the contents of the user-settable memory area or overwrites it with the contents of the non-user-settable area—depending on the readout type.

FIG. 6 shows an option for heating element timing for hot air (re)circulation mode. The duration of the heating cycle of 80 seconds is plotted in steps of 1/100 on the abscissa and the heating elements H1-H5 controlled in different ways are plotted on the ordinate. In this case are the heating elements are labeled as follows: H1 is the inner heating circuit of a two-circuit overhead heating element, H2 is the inner heating circuit of a two-circuit bottom heating element present in the cooking zone, H3 is the outer heating circuit of the two-circuit bottom heating element, H4 is a ring heating element accommodated between the rear wall of the muffle and the rear wall of the housing and H5 is the outer heating circuit of the two-circuit overhead heating element. It can be seen that H1 is only activated for initialization, whereas for example the single-circuit ring heating element H4 operates continuously. Within the cycle which represents the smallest unit of heat for the hot air operating mode the percentage of heat power of the individual heating elements used is distributed as follows: H1 (maximum power Pmax=1500 W at 230 V) 0%; H2 (Pmax=1200 W): 17%; H3 (Pmax=900 W): 20%; H4 (Pmax=900 W): 100%; and H5 (Pmax=1200 W): 50%. In normal operation the relative heat power is typically but not necessarily maintained. By contrast the heat power can for example be adapted to the temperature in the cooking space. It should be noted in this context that the maximum total power at any point in time may not exceed 3.6 KW here. The fan also operates in hot air mode in order to fill the cooking space with the heated air as evenly as possible.

FIG. 7 now shows, in a similar diagram to that shown in FIG. 6, the heat power distribution in a fast-cook mode, which is especially suitable for ready-cooked frozen products. In this case the percentage heat power used in each case is set as follows: H1: 100%, H2: appr. 50%, H3: 0%, H4: 100% and H5: appr. 50%. In this exemplary embodiment this corresponds, for operation at 230 V, to the following approximate proportions of the total heat power averaged over the cycle: H1: appr. 42% of 3.6 KW; H2: appr. 17%; H3: 0%; H4: appr. 25% and H5: appr. 17%. The temperatures reached in the closed cooking space typically lie between 200° C. and 280° C. with typical heating times of 5 to 25 minutes. Expediently the heat conductors H1, H4 and H5 installed permanently in the heating space are operated with running fans, i.e. in hot air operating mode.

By means of the maximum power of 3.6 KW and the benefit of the contact heat created by the two-circuit bottom heat element of the glass ceramic (with or without metal tray/mold/foil tray etc.) such products are brought up to their serving temperature very quickly. The heating duration can be set as a function of the mass, structure (thickness, height) and/or the initial pre-cooked state of the food to be cooked. With the fast-cook function it is advantageous for the user only to have to allocate the food to a food class (e.g. pizza, potato products, baking items, roasting items etc.), e.g. by setting of a suitable heating program, and for the heating program then to set the optimum temperature and duration automatically. The weight of the food for example can also be entered if necessary. It is generally advantageous for the user to be able to modify the heat parameters.

With all embodiments other heating elements or differently designed heating elements could also be used, e.g. radiant heating elements etc.

The embodiments described above are not to be understood as restrictive.

### LIST OF REFERENCE SYMBOLS

1 Housing
2 Wall
3 Cooking space
4 Viewing window
5 Muffle
6 Muffle opening
7 Base door
8 Work surface
9 Drive motor
9 Lifting element
11 Control element
12 Control panel
13 Control circuit
14 Display elements
15 Cooking zone
   16 Hotplate heating element
   17 Hotplate heating element
   18 Radiant heating element
   19 Glass ceramic plate
20 Holder part
21 Food support
22 Overhead heating element
23 Fan
24 Seal
25 Memory unit
26 User-settable memory
27 Non-user-settable memory
28 Microcontroller
H1 Inner top heat
H2 Inner bottom heat
H3 Outer bottom heat
H4 Ring
H5 Outer top heat

1-17. (canceled)

18. A method for heating food portions in an elevated cooking appliance having at least one muffle with a muffle opening that delimits a heating space, at least one base door for closing the muffle opening, and a cooking zone disposed on the base door, the method comprising the steps of:
(a) placing at least one food portion on the cooking zone, with the at least one base door of the elevated cooking appliance in an open state;
(b) closing the at least one base door of the elevated cooking appliance; and
(c) heating the at least one food portion in the closed elevated cooking appliance by at least contact heat from the cooking zone.

19. The method as set forth in claim 18 further including heating the food portions by hot air.

20. The method as set forth in claim 18 further including heating the food portions by radiant heat.

21. The method as set forth in claim 18 wherein the food portions are in direct contact with the cooking zone.

22. The method as set forth in claim 18 wherein the food portions are received in a roasting dish, in a foil container or on a metal sheet which is in direct contact with the cooking zone.

23. The method as set forth in claim 18 wherein the cooking zone includes at least one heating element and a cover made of glass ceramic or thin sheet metal.

24. The method as set forth in claim 18 wherein the food portions include are a cake.

25. The method as set forth in claim 18 wherein the food portions include a frozen meal.

26. The method as set forth in claim 25 wherein the frozen meal has been pre-cooked.

27. The method as set forth in claim 25 further including operating the cooking appliance substantially at its maximum heat power.

28. The method as set forth in claim 27 wherein the maximum heat power of the cooking appliance is approximately 3.6 KW.

29. The method as set forth in claim 25 wherein the cooking appliance is operated with a heat power of up to forty percent (40%) of the average of the total heat power of the cooking appliance.

30. The method as set forth in claim 29 wherein the cooking appliance is operated with a heat power of up to thirty percent (30%) on average of the average of the total heat power of the cooking appliance.

31. The method as set forth in claim 30 wherein the cooking appliance is operated with a heat power between fifteen percent (15%) and twenty percent (20%) of the average of the total heat power of the cooking appliance.

32. The method as set forth in claim 31 wherein the cooking appliance is operated with a heat power of between fifteen percent (15%) to twenty percent (20%) of the average of the total heat power of the cooking appliance.

33. The method as set forth in claim 31 wherein additional heat power is distributed by a ring heating element and/or an overhead heating element.

34. The method as set forth in claim 33 wherein the heat power of the ring heating element amounts to approximately twenty-five percent (25%) of the total heat power and the heat power of the overhead heating element amounts to approximately fifty-five percent (55%) to sixty-five percent (65%) of the total heat power.

35. The method as set forth in claim 27 further including operating a fan for creating hot air wherein the fan is operated at substantially maximum fan power.

36. A high-level cooking appliance for heating a meal in a closed state comprising:
a muffle; at least one muffle with a muffle opening which delineates a heating space;
at least one base door for closing the muffle opening;
a cooking zone arranged on the base door; the cooking zone adapted to receive food portions, without cooking utensils; and
wherein the food portions are adapted to be heated in the high-level cooking appliance by at least contact heat from the cooking zone when the muffle opening is closed.

37. The high-level cooking appliance as set forth in claim 36 wherein the cooking zone includes at least one radiant heating element.
